(19) United States
(12) Patent Application Publication
(10) Pub. No.: US 2006/0074790 A1
(43) Pub. Date: Apr. 6, 2006

(54) Method for marketing leased assets

(76) Inventor: Jeremy Anspach, Sullivan's Island, SC (US)

Correspondence Address: HOLLANDER LAW FIRM, P.L.C., SUITE 305, 10300 EATON PLACE, FAIRFAX, VA, 22030, US

(21) Appl. No.: 11/239,843

(22) Filed: Sep. 30, 2005

Related U.S. Application Data
(60) Provisional application No. 60/616,484, filed on Oct. 6, 2004.

(51) Int. Cl. G06Q 40/00

(52) U.S. Cl. 705/35

(57) ABSTRACT

A method of re-marketing a leased asset includes receiving an asset prior to or at the end of a lease term; inspecting the asset; photographing the asset; listing the asset and its photograph and condition on a web site; and receiving a request to buy the asset from a buyer.

This application claims priority of provisional application U.S. Ser. No. 60/616,484, filed Oct. 6, 2004, the disclosure of which is incorporated by reference in its entirety.

### FIELD OF INVENTION

The present invention is directed to marketing and selling leased assets whose leases have not expired and/or are about to expire, in particular re-marketing leased assets for banks, financial institutions, and other asset owners.

### BACKGROUND OF INVENTION

The leasing of assets, such as vehicles, presents problems to banks and financial institutions (i.e., lessors) when the lease term ends.

For example, when the lease term for a vehicle ends, the customer (i.e., lessee) has the option to purchase the vehicle for a residual value that is typically determined at the beginning of the lease term. The majority of customers choose not to exercise this option because the residual price often exceeds the market value. Thus, banks or financial institutions offer vehicles to the dealer from whom the vehicle was leased or to a dealer that is in the current geographic location of the lessee at a reduced price. A majority of dealers decline this offer because the value often exceeds the current wholesale market value or wholesale auction value.

Thus, banks and financial institutions are left with a large number of vehicles that are sold at a wholesale auction. Instead of getting the predetermined or perceived residual value of the vehicle, the banks and financial institutions often receive much less at an auction. This has lead to widespread losses for lessors.

### SUMMARY OF INVENTION

According to the present invention a third party company, other than a lessor from whom an asset is leased, may take physical possession of a leased asset nearing the end of the lease term for a period of time.

The third party company inspects the asset. In the case of a vehicle, the third party company inspects the vehicle to assess the condition of the vehicle; to determine whether there is any damage; and also to determine the actual mileage of the vehicle. In addition, each vehicle is photographed in detail. Other information about the vehicle may be obtained from the lessor, for example, vehicle identification number (VIN), make, model, color, and the like. Details of the vehicle history or the options may be obtained from the vehicle manufacturer or from another company.

The third party company then lists the asset, for example a vehicle, along with the photographs and other relevant criteria, on a web site that is accessible via an Internet connection. The third party company may maintain the web site or may utilize an outside commercial service to list the asset on its web site. Any potential buyer, public or wholesale, having access to the Internet can accordingly search the web site for assets and purchase those assets.

Advantages of the present invention include the ability to market leased assets before their lease term has ended or after the lease term has expired. The present invention allows these assets to be marketed directly to consumers, dealers, corporations, and any other individuals interested in purchasing the asset. As a result, where the asset is a vehicle, banks and financial institutions are able to receive greater value for their leased vehicles than they would utilizing current wholesale auction methods.

### DETAILED DESCRIPTION OF INVENTION

According to the present invention a third party company, other than a lessor from whom an asset is leased, may take physical possession of the leased asset that is nearing or at the end of its lease term for a period of time. In another embodiment, the third party may take physical possession of a rented asset that is nearing or at the end of its rental period.

According to the present invention, the asset may be any type of asset that is leased or rented for a predetermined period of time. The asset may be, but is not limited to, motor vehicles, boats, planes, trains, and the like. According to the present invention, a motor vehicle may be any type of motor vehicle such as a car, truck, van, sedan, bus, motorcycle, and the like. The following discussion is directed to an embodiment in which the asset is a leased vehicle. However, the present invention is not limited thereto.

The third party company may offer an incentive for a lessee to turn in a leased vehicle early. The incentive may be, for example, an inducement of any kind that benefits the lessee and or any other parties involved in the lease. In embodiments, the inducement may be a coupon for automotive or other services.

I. Inspection

The third party company may take possession of a leased vehicle about 30-120 days, preferably about 90 days, before the end of the lease term. After taking possession of the vehicle, the third party company conducts a comprehensive inspection of the vehicle to assess the condition of the vehicle, including any damage, and the actual mileage of the vehicle. In embodiments, the inspection may be done by a subcontractor or at another facility. If the inspection is performed by a subcontractor or at another facility, the third party may not take possession of the vehicle according to the present invention. In another embodiment, the asset owner, lessor, bank, or financial institution may take possession of the vehicle for some period of time, for example, to conduct or authorize the inspection. Accordingly, the third party company may or may not have possession of the vehicle in this embodiment.

The inspection accounts for any physical or mechanical changes in condition, for example in the bodywork, glass, wheels, interior, engine, and the like. The inspection also allows for the discovery of maintenance issues or problems. Any changes or problems with the vehicle may be factored into the selling price of the vehicle. In addition, the changes in condition may be noted to the lessor, so that the lessor may charge any necessary surcharges to the lessee under the terms of his existing lease agreement.

In embodiments, the third party company or subcontractor may take detailed photographs of the vehicle. Preferably, the photographs are done in a standard format so that each vehicle has the same background, lighting, and perspectives. The taking of photographs during vehicle inspection is necessary because a manufacturer's or lessor's file photographs would not give a potential buyer an accurate description of the vehicle's current condition.

In addition to information resulting from the inspection, the third party company may obtain data from the lessor, for example, vehicle identification number (VIN), year, make, model, color, financial details, and lease terms. Other data, such as options, vehicle history, specifications, and the like, may be obtained from other sources, such as the vehicle manufacturer; vehicle history companies such as Carfax® and the like; or any institution which has information pertaining to the leased vehicle. In view of the inspection and other information, the third party company establishes a selling price for the vehicle which most likely will be higher than the price that could be obtained at a wholesale auction.

II. Listing on the Web

All data may be placed in a categorized and searchable database. In a preferred embodiment, information contained in the database, along with the pictures of the vehicle, may be listed on a web site or web portal that is accessible via the Internet. The third party company may maintain the web site or may utilize an outside commercial service, web site, or internet service provider to list the vehicle on the world wide web.

The web site allows a potential buyer to search for vehicles by at least one specific criteria, for example, by selling price, make, model, mileage, color, options, geographic location of the vehicle, lessor, combinations thereof, and the like. The web site also contains information regarding the current condition of the vehicle or any problems with the vehicle found as a result of the inspection. Otherwise, a high percentage of dissatisfied buyers would arise if the vehicle delivered differed in any regard to the vehicle presented for sale on the web.

In embodiments, a potential buyer may use a personal computer, cellular telephone, handheld device, or any other device having an Internet connection to access the web site. Various types of connection to the web site are feasible, for example, dial-up connections, DSL connection, a cable connection, a wireless connection, and the like. According to the present invention, communications may also occur over a local area network, wide area network, an Intranet, a virtual private network, or any manner in which computers can be integrated together for communication purposes.

After the potential buyer enters the pertinent search criteria, a list of vehicles matching that criteria is displayed. The displayed list may include photographs of the vehicles. The displayed list may also include the date when the lease term of the vehicle expires. If the buyer sees a vehicle he or she likes, the buyer may purchase the vehicle after the expiration of the least term. In another embodiment according to the present invention, the lessor may agree to the sale of a vehicle before the lease term expires. The third party company may offer to finance or re-lease the vehicle through the lessor as an incentive to sell the vehicle before the existing lease term expires.

In an alternative embodiment according to the present invention, the vehicle may be listed on a web site as part of an online auction. Thus, each potential buyer for a vehicle would place a bid on that vehicle and the minimum bid or the latest bid would be part of the information displayed for each vehicle.

In another embodiment according to the present invention, some of the information contained on the web site may be presented in a kiosk in a similar or alternative format. This information may be specific to a geographic location and/or to a specific vendor and the like. A kiosk typically contains a display screen, keyboard, processor, and memory. The categorized and searchable database may be contained within the kiosk, so that a potential buyer may search for a vehicle by specific criteria. An internet connection may or may not be required. The kiosks may be located at a bank, a financial institution, a dealer, or in some other publicly accessible place.

In other embodiments, some of the information contained in the database and photographs of vehicles may be listed via any broadcasting, electronic, telecommunication, satellite, radio, or television medium, and the like. In one embodiment, the information and photographs of a vehicle may be broadcast on a television shopping channel along with an identifier (e.g., SKU number). Using the identifier, a buyer may purchase the vehicle in full or may make a deposit on the vehicle. In embodiments, the payment or deposit may be made by any electronic means (e.g., check-by-phone, credit card, wire transfer, direct deposit).

III. Purchase of the Vehicle

According to the present invention, the third party company may handle the purchase of the vehicle.

In embodiments, the buyer may pay for the vehicle through a secure means of transaction, such as Paypal, certified check, cash, and the like. The payment may be directed straight from the buyer to a secure account (e.g., an escrow account). Such secure accounts may be established for each bank or financial institution (i.e., lessor). In preferred embodiments, the third party company would only be able to deduct a fee for the sale of the vehicle from the secure account. The third party company and lessor may agree on the third party company's fee for selling each vehicle. The funds in the account (vehicle sales price minus third party company fee) may then be transferred directly to the lessor. As a result, the lessor has no risk of non-payment or risk that the third party company may withhold funds, since the third party has no access to the secure accounts except for collecting a fee for each sale.

In another embodiment, the buyer may pay a deposit for the vehicle through a secure means of transaction. The deposit may be directed to a secured account. If the vehicle's condition changes between the deposit date and delivery to the buyer, the selling price may be adjusted to accommodate any changes in condition. If the vehicle is not acceptable under a buyer's agreement, the buyer may be offered a comparable vehicle, if applicable. If the vehicle is acceptable, the buyer may submit the balance of the vehicle selling price. The balance may be directed to the secured account. The third party company would deduct a fee for the sale of the vehicle from the secure account.

In another embodiment according to the present invention, the third party company may offer to finance the vehicle if the buyer does not have sufficient funds to pay for the vehicle in full. The third party company may offer financing (e.g., a loan) through the original lessor or through another bank or financial institution. In another embodiment, the buyer may re-lease the vehicle through the original lessor or through an independent financial institution, with multiple lease terms being offered via the web site.

IV. Refurbishment and Delivery

After completion of the sale, loan, or re-lease, each vehicle may be refurbished and prepped for final delivery. In one embodiment, the refurbishment and prep work may be done prior to the original lease completion.

The refurbishment of the vehicle may be accomplished by the third party company. In the alternative, the third party company may transport, or manage the transportation of, the vehicle to an authorized refurbishment center (e.g., a car dealer). If an authorized refurbishment center such as a dealer is used, the dealer may be offered advertising or a listing of inventory on the web site in exchange for their services in refurbishment, for example, as part of a promotional package and the like. In addition, the buyer would have an option of premium servicing at the dealer.

After refurbishment, the vehicle is transported to the new owner or lessee. Delivery of the refurbished vehicle from the refurbishment center (e.g., dealer) may be affected by the geographic location of the buyer.

An extended warranty may be included or may be an option for vehicles listed on the web site. The extended warranty may be offered by the lessor or by another bank or financial institution or a authorized dealer or a warranty company. In embodiments, the third party company may fulfill all terms of the extended warranty through authorized dealers.

What is claimed is:

1. A method of re-marketing a leased asset, comprising:
receiving an asset prior to or at the end of a lease term;
inspecting the asset;
photographing the asset;
listing the asset and its photograph and condition on a web site; and
receiving a request to buy the asset from a buyer.

2. A method according to claim 1, wherein a third party other than the lessor from whom the asset was leased receives and takes possession of the asset from a lessee.

3. A method according to claim 2, wherein the third party receives and takes possession of the asset from about 30 to about 120 days prior to the end of the lease term.

4. A method according to claim 1, wherein the asset is selected from the group consisting of a plane, boat, motor vehicle, car, truck, van, sedan, bus, and motorcycle.

5. A method according to claim 1, wherein the asset is inspected for damage.

6. A method according to claim 1, wherein the asset is a motor vehicle and is inspected to determine actual mileage.

7. A method according to claim 1, further comprising obtaining information about the asset from the lessor of the asset.

8. A method according to claim 7, wherein the asset is a motor vehicle and the information obtained from the lessor is selected from the group consisting of vehicle identification number, make, model, color, options, financing details, lease terms, and combinations thereof.

9. A method according to claim 8, further comprising obtaining information about the service history of the motor vehicle.

10. A method according to claim 1, further comprising maintaining a database with information on the asset and at least one photograph of the asset, wherein said database is searchable by the buyer according to at least one criteria.

11. A method according to claim 10, wherein the asset is a motor vehicle and the at least one criteria is selected from the group consisting of selling price, mileage, color, make, model, options, lessor, geographic location, and combinations thereof.

12. A method according to claim 2, further comprising receiving payment from the buyer, wherein said payment is directed to a secured account associated with the lessor.

13. A method according to claim 12, wherein the third party deducts a fee from the secured account.

14. A method according to claim 1, further comprising conducting an online auction of the asset, wherein multiple buyers bid on the asset.

15. A method according to claim 1, further comprising receiving payment from the buyer to purchase the asset.

16. A method according to claim 15, further comprising refurbishing the asset after receiving payment from the buyer.

17. A method according to claim 16, further comprising delivering the asset to the buyer after refurbishment.

18. A method according to claim 15, wherein the buyer pays a deposit for the asset and the deposit is directed to a secured account.

19. A method according to claim 18, wherein the buyer submits the balance of the selling price for the asset and the balance is directed to the secured account.
